(19) United States
(12) Patent Application Publication
(10) Pub. No.: US 2017/0351753 A1
(43) Pub. Date: Dec. 7, 2017

(54) SEMANTIC LAYERS FOR SECURE INTERACTIVE ANALYTIC VISUALIZATIONS

(71) Applicant: iCharts, Inc., Sunnyvale, CA (US)

(72) Inventors: Seymour Duncker, Los Altos, CA (US); Andrey Yruski, San Francisco, CA (US)

(21) Appl. No.: 15/173,354

(22) Filed: Jun. 3, 2016

(51) Int. Cl. G06F 17/30; G06F 17/22

(52) U.S. Cl. CPC G06F 17/30716; G06F 17/2288; G06F 17/30696

(57) ABSTRACT

An analytic visualization, such as a chart or graph, embedded into a container. The container is embedded into a portal, such as a web page, that is viewable by a viewer device. To update the analytic visualization, an update server receives a data request from the viewer device or from a container host server that hosts the container. The update server generates a data processing instruction based on the data request, which it sends to data sources. The data sources store a full dataset, and are configured to extract a processed dataset from the full dataset based on the data processing instructions. The update server receives the processed dataset from the data sources, applies one or more semantic layer operations to the processed dataset, and generates a visualization update based on the result. The update server then transmits the visualization update to the viewer device or container host server.

### BACKGROUND

### 1. Field of the Invention

The present invention generally concerns securely generated analytic visualizations. More specifically, the present invention concerns automated remote manipulation of data via semantic layers for use in a securely and dynamically generated interactive analytic visualizations.

### 2. Description of the Related Art

With the continued proliferation of computing devices and the ubiquitous increase in Internet connectivity, dealing with vast amounts of complex data has become a norm in business and consumer markets. Analyzing such data while the data is still arranged in spreadsheets, tables, databases, and other data structures can often be slow, difficult, and unwieldy. High volumes of data can be difficult to analyze simply due to the sheer amount available for review. Complex data can be similarly difficult to analyze, as a user may need to keep track of various rows and columns and perform mathematical operations such as averages or conversions. Keeping track of manipulations to such data can be difficult as well, as many databases are regularly fed new data, and users often have various saved versions that are often not up-to-date and may include personalized manual edits such as sort operations, deletions, duplications, or additional rows or columns with calculations.

Because large amounts of complex data can be difficult to analyze, it is often helpful to arrange such data into analytic visualizations, such as charts or graphs. Typically, a user wanting to generate a chart or graph manually copies and pastes data from its original format into a spreadsheet software application that is capable of generating charts or graphs. The user then typically exports the chart or graph as a static image into a document or a web page.

However, static-image-based charts and graphs cannot easily be updated to include newer, more up-to-date data without going back to the spreadsheet software application, manually entering the new data in, and generating a new chart or graph. Static-image-based charts and graphs likewise cannot be interactive, in that viewers cannot choose to filter the data shown, to perform conversions or other mathematical operations on the fly, to manipulate scales in the chart or graph, or to change one type of chart or graph into another type of chart or graph.

Analytics systems that generate charts or graphs are also typically not very secure. While a user might choose to generate a chart based on a tiny fraction of a dataset, such as a chart based on only United States sales from a larger dataset of worldwide sales, the user would typically generate such a chart by having the entire larger dataset transferred over and narrowing the data locally. More data being transferred over a network means that more data is put at risk of being stolen, for example via a man-in-the-middle network attack. Furthermore, while an organization might allow a high-ranking officer such as a Chief Executive Officer (CEO) to view the entire dataset of worldwide sales, the organization might prefer that other users, such as shareholders, low-level employees, or contractors, be able to view only whatever subset of the worldwide sales dataset they need to see without risking leaks of the rest of the dataset.

Therefore, there is a need in the art for improved secure analytic visualization methods and systems with interactive semantic layer data manipulation functionality.

### SUMMARY OF THE PRESENTLY CLAIMED INVENTION

A first claimed embodiment of the present invention concerns a system for providing analytic visualization data. The system includes a memory storing a semantic layer operation. The system also includes a communication transceiver communicatively coupled to at least a data source, the communication transceiver receiving a data request. The system also includes a processor coupled to the memory and to the communication transceiver. Execution of instructions stored in the memory by the processor performs system operations. The system operations include generating data processing instructions based on the data request and triggering transmission of the data processing instructions to the data source via the communication transceiver. The system operations also include receiving a processed dataset from the data source, the processed dataset being at least a subset of a full dataset stored at the data source, and modifying the processed dataset by performing the semantic layer operation on the processed dataset. The system operations also include generating a visualization update based on the modified processed dataset and triggering transmission of the visualization update via the communication transceiver, thereby updating an analytic visualization that is displayed by a viewer device.

A second claimed embodiment of the present invention concerns a method of providing analytic visualization data. The method includes storing a semantic layer operation in a memory and receiving a data request. The method also includes generating data processing instructions based on the data request and transmitting the data processing instructions to a data source. The method also includes receiving a processed dataset from the data source, the processed dataset being at least a subset of a full dataset stored at the data source, and modifying the processed dataset by performing the semantic layer operation on the processed dataset. The method also includes generating a visualization update based on the modified processed dataset and transmitting the visualization update, thereby updating an analytic visualization that is displayed by a viewer device.

A third claimed embodiment of the present invention concerns a stored program for providing analytic visualization data that is stored on a non-transitory computer-readable storage medium. The stored program may be executable by a processor to perform an exemplary method for providing composite analytic visualization data. The executable program method includes storing a semantic layer operation in a memory and receiving a data request. The method also includes generating data processing instructions based on the data request and transmitting the data processing instructions to a data source. The method also includes receiving a processed dataset from the data source, the processed dataset being at least a subset of a full dataset stored at the data source, and modifying the processed dataset by performing the semantic layer operation on the processed dataset. The method also includes generating a visualization update based on the modified processed dataset and transmitting the visualization update, thereby updating an analytic visualization that is displayed by a viewer device.

### BRIEF DESCRIPTION OF THE FIGURES

FIG. 1 illustrates data transfers within a secure analytic visualization ecosystem.

FIG. 2A illustrates data transfers and data manipulations for updating an analytic visualization not factoring in a container host server.

FIG. 2B illustrates data transfers and data manipulations for updating an analytic visualization including data transfers and data manipulations involving a container server.

FIG. 3 illustrates an exemplary portal user interface illustrating semantic layer operation selections.

FIG. 4 illustrates various analytic visualization formats.

FIG. 5 is a block diagram of an exemplary computing device that may be used to implement an embodiment of the present invention.

### DETAILED DESCRIPTION

An analytic visualization, such as a chart or graph, embedded into a container. The container is embedded into a portal, such as a web page, that is viewable by a viewer device. To update the analytic visualization, an update server receives a data request from the viewer device or from a container host server that hosts the container. The update server generates a data processing instruction based on the data request, which it sends to data sources. The data sources store a full dataset, and are configured to extract a processed dataset from the full dataset based on the data processing instructions. The update server receives the processed dataset from the data sources, applies one or more semantic layer operations to the processed dataset, and generates a visualization update based on the result. The update server then transmits the visualization update to the viewer device or container host server.

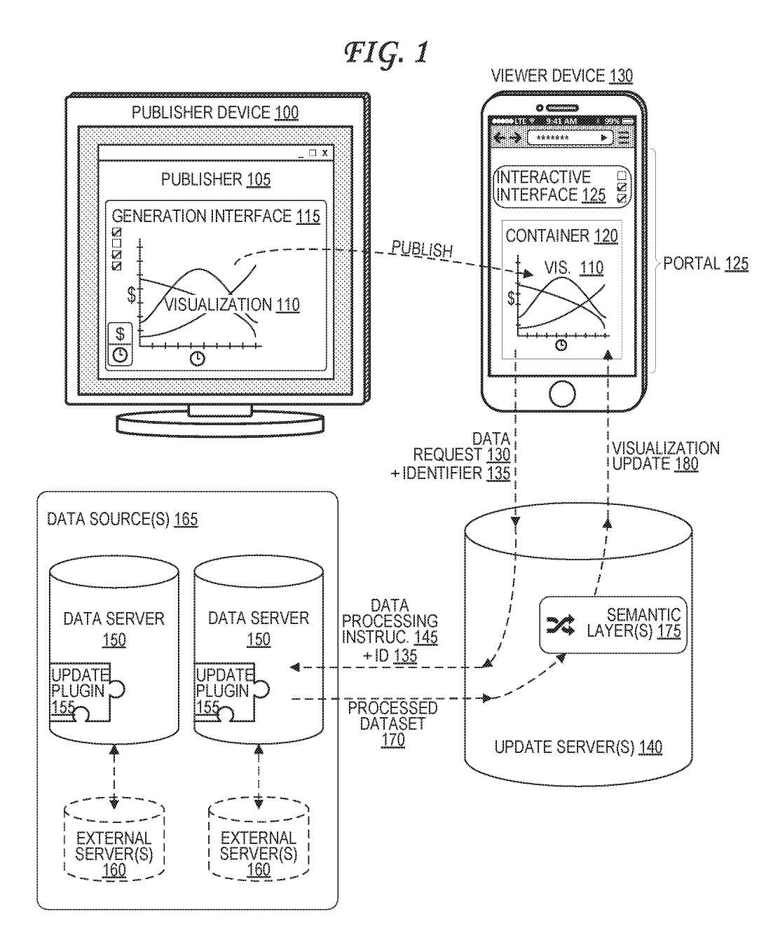

FIG. 1 illustrates data transfers within a secure analytic visualization ecosystem.

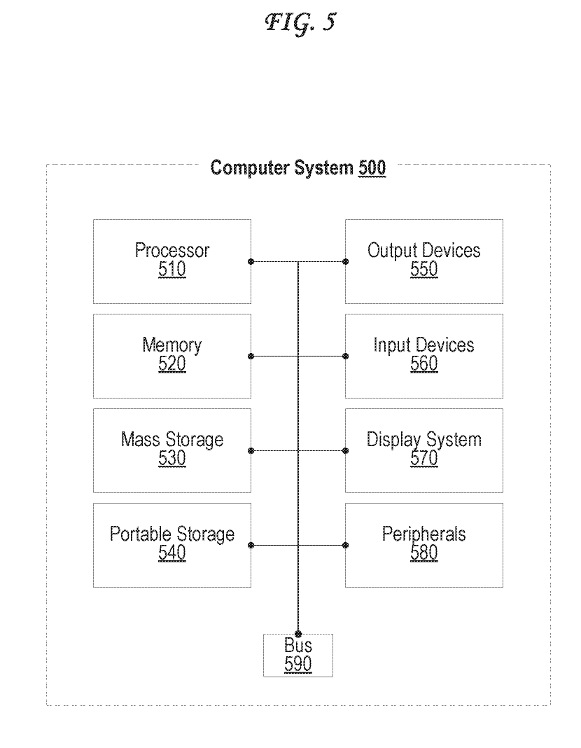

The secure analytic visualization ecosystem includes a viewer device 130. The viewer device 130 of FIG. 1 is illustrated as a smartphone device, but may be any type of computing device 500, or may include at least a subset of the components of the computing device 500 illustrated in FIG. 5.

The viewer device 130 of FIG. 1 is illustrated viewing a portal 125, which may be a markup page hosted and served via the public Internet or via a private intranet. The portal 125 may alternately be an electronic document whose contents may change based on data supplied via the public Internet or via a private intranet. The portal 125 may alternately be an interface of a software application that is stored on the viewer device 130 and executed by the viewer device 130.

The portal 125 of FIG. 1 includes a container 120, which is embedded into the portal 125. The container 120 may be embedded into the portal 125 via markup language, scripting language, or some combination thereof. The markup language may include Hyper Text Markup Language (HTML), Extensible Markup Language (XML) JavaScript Object Notation (JSON), some variant thereof, or some combination thereof. The scripting language may include javascript, PHP Hypertext Preprocessor (PHP), Ruby, Python, Java, or another appropriate language. For example, the container 120 may be embedded into the portal 130 via an HTML iFrame or a PHP include.

An analytic visualization 110 is displayed via the container 120 of FIG. 1. The analytic visualization 110 is a chart, a graph, or some combination thereof. The analytic visualization 110 is dynamic and automatically updates in a number of ways. For example, the analytic visualization 110 can automatically update upon receipt of input via an interactive interface 125, for example identifying that the analytic visualization 110 should chart United States sales data in addition to European sales data, or identifying that the analytic visualization 110 should convert currency units, or identifying that the analytic visualization should be graphed using a logarithmic scale or an exponential scale rather than a linear scale. The analytic visualization 110 can automatically update in real-time, for example by adding data automatically to the analytic visualization 110 as more data is added to the data source(s) 165 that the analytic visualization 110 is based on, or by automatically subtracting data from the analytic visualization 110 as data is removed from the data source(s) 165. The analytic visualization 110 can alternatively be set to automatically update periodically based on a predetermined update time interval, such as every 5 seconds, or every 15 minutes, or every hour, or every 2 days. The analytic visualization 110 can alternatively be set to automatically update according to a predetermined calendar schedule, such as by updating on every second Tuesday of the month at a predetermined time, or by updating when the sun rises or sets, or by updating when a calendar event/appointment occurs according to a calendar application. The analytic visualization 110 may be displayed through the container 120 through the use of HTML, XML, JSON, images, javascript, Ruby, Python, Java, Adobe Flash, Microsoft ActiveX, Microsoft Silverlight, or some combination thereof.

The analytic visualization 110 may optionally have been originally designed via a generation interface 115 of a publisher 105. The publisher 105 may be an application or web page executed or viewed via a publisher device 100. Publisher device 100 of FIG. 1 is illustrated as a desktop computer device, but may be any type of computing device 500, or may include at least a subset of the components of the computing device 500 illustrated in FIG. 5. The publisher 105 may have “published” the analytic visualization by generating the container 110 and optionally by generating at least a portion of the portal 125, such as an embed code.

The interactive interface 125 of the portal 125 may receive inputs from a user of the viewer device 130. The inputs may allow a user of the viewer device 130 to select filters identifying which subsets of a full dataset should be used within the analytic visualization and to select semantic layer operations 175 that allow the user to perform commonly-used calculations on the data. The interactive interface 125 may include various graphical user interface (GUI) elements, such as buttons, menus, checkboxes, radio buttons, alphanumeric entry fields, or combinations thereof. The interactive interface 125 may in some cases be extended to include physical interface elements of the viewer device, such as switches, knobs, levers, physical buttons, keyboards, keypads, mice, joysticks, touchscreens, or combinations thereof.

When the portal 125 is loaded by the viewer device 130, the container 120 must first load the data to be included within the analytic visualization 110. This first loading of data, and any updates afterwards, shall both be referred to herein as an update operation.

The update operation begins with an update server 140 receiving a data request 130 and, optionally, an identifier 135. The data request 130 is based on what the analytic visualization 110 was generated to show (e.g., as decided at the publisher 105) as well as any inputs received at the interactive interface 125. The identifier 135 identifies the user of the viewer device 130, the viewer device 130 itself, or both. The identifier 135 may include a certificate that can be verified by a Certificate Authority (CA), a username, a password, a biometric reading, at least a portion of a browser cookie, or some combination thereof.

The update server 140 then generates a data processing instruction 145 based on the data request 130 and optionally based on the identifier 135. The update server 140 then transmits the data processing instruction 145 to one or more data source(s) 165, and optionally transmits the identifier 135 to the one or more data source(s) 165 as well.

The term “full dataset” as used herein refers to all of the data collectively stored within the data source(s) 165 that is potentially usable for an analytic visualization 110. The full dataset may be stored entirely on a single data server 150 or a single external server 160, or may be spread across one or more data server(s) and/or one or more external server(s) 160 that each contain a partial dataset.

Each data server 150 includes an update plugin 155, which includes instructions executable by a processor of the data server 150 to extract data from the full dataset to include in a processed dataset. External servers do not include the update plugin 155, but may be queried by a data server 150 as needed for their respective portions of the full dataset. If there are multiple data servers 150 within the set of data sources 150, these data servers 150 may communicate with each other as laid out in the instructions within their respective update plugins 155 to generate the processed dataset 170 from on the full dataset based on the data processing instruction 145.

The data source(s) 165 may optionally also generate the processed dataset 170 based on the identifier 135. A processed dataset 170 generated based on the identifier 135 may omit data that the user of the viewing device 130 does not have authorization to view, such as when the user of the viewing device 130 is determined to be a low-level shareholder rather than a board director, or when the user of the viewing device 130 is determined to be a low-level employee rather than a high-ranking officer. A processed dataset 170 generated based on the identifier 135 may omit data that is not authorized to be displayed via the viewing device 130, such as when the viewing device 130 is determined to be compromised by viruses/spyware, or when a viewing device 130 does not include certain files or software applications, or when the viewing device 130 is determined to be located in too public a location, or when the viewing device 130 is connected to a network that is not secure enough, or when a viewing device 130 is determined to not be connected to a particular private network.

The update server 140 then receives the processed dataset 170 from the data source(s) 165. The update server 140 typically does not ever receive the full dataset, except for the rare scenario where the analytic visualization 110 uses all of the data from the full dataset, and the processed dataset 170 thus includes the entire full dataset. Thus, the full dataset is generally never transmitted and remains within the data source(s) 165. This helps prevent the full dataset from being leaked or compromised while in transit, making the entire analytic visualization ecosystem of FIG. 1 secure.

Upon receipt of the processed dataset 170, the update server 140 performs one or more semantic layer operations 175 on the processed dataset 175 based on the data request 130. For example, the semantic layer operations 175 may include sums, differences, products, ratios, percentages, unit conversions, scale changes, and more complex mathematical operations. Such a mathematical operations may include addition operations, subtraction operations, multiplication operations, division operations, exponent operations, root operations, mean operations, median operations, mode operations, standard deviation operations, logarithmic operations, trigonometric operations, statistical operations, derivative operations, integral operations, limit operations, matrix operations, vector operations, Fourier transform operations, unit conversion operations, or some combination thereof. Semantic layer operations 175 may also include sorting operations. In some cases, semantic layer operations 175 may also include non-mathematical operations, such as duplication or removal of one or more data entries from within the processed dataset 170.

The semantic layer operations 175 may include global semantic layer operations that are available to all users and/or all viewer devices 130. The semantic layer operations 175 may also include group-based semantic layer operations that are available only to a certain subset of users and/or viewer device 130. Certain semantic layer operations, for example, may need to be purchased, and would then only be available to users corresponding to a user account that has purchased a license to those semantic layer operations, or would only be available for those viewer devices 130 for which a license to those semantic has been purchased. Some semantic layer operations may be available only to a specific group, such as accountants in an organization, because they might not be useful to anyone else. Some semantic layer operations might only be available to certain authorized users, which may be checked based on the identifier. Some semantic layer operations might only be available to viewer devices 130 that are connected to a particular private network or local intranet. Some semantic layer operations 170 may be user-defined, for example via the viewer device 130 or the publisher device 100. Some semantic layer operations 170 may be mandatorily applied for certain users or certain viewer devices 130—for example, while a company director might be allowed to see day-to-day sales, a low-level shareholder might only be allowed to see yearly totals.

Storing and performing the semantic layer operations 170 at the update server 140 helps speed up work so by storing how certain tasks can be accomplished and automated. Storing and performing the semantic layer operations 170 at the update server 140 also helps make the analytic visualization ecosystem of FIG. 1 more secure by making it possible to keep certain data, such as day-to-day sales data, inaccessible from certain viewer devices 130 or to certain users of certain viewer devices 130 who should only be shown data after a particular semantic layer operation 175 is applied, such as a “yearly total” semantic layer or a “year-to-date (YTD)” semantic layer.

The update server 140 may optionally perform one or more semantic layer operations 175 on the processed dataset 170 based on the identifier 135. For example, some users might only be authorized to view total monthly or yearly sales values rather than real-time sales values or daily sales values. This may be the case, for example, when the user of the viewing device 130 is determined to be a low-level shareholder rather than a board director, or when the user of the viewing device 130 is determined to be a low-level employee rather than a high-ranking officer. Similarly, some viewer devices 130 might only be authorized to display total monthly or yearly sales values rather than real-time sales values or daily sales values. This may be the case when, for example, the viewing device 130 is determined to be compromised by viruses/spyware, or when a viewing device 130 does not include certain files or software applications, or when the viewing device 130 is determined to be located in too public a location, or when the viewing device 130 is connected to a network that is not secure enough, or when a viewing device 130 is determined to not be connected to a particular private network.

Once the update server modifies the processed dataset 170 via the semantic layer operations 175, it generates a visualization update 180. The visualization update 180 may include the processed dataset 170 modified by the semantic layer operations 175, or may include the rendered analytic visualization, or may include some intermediate step in between, or may include some combination thereof.

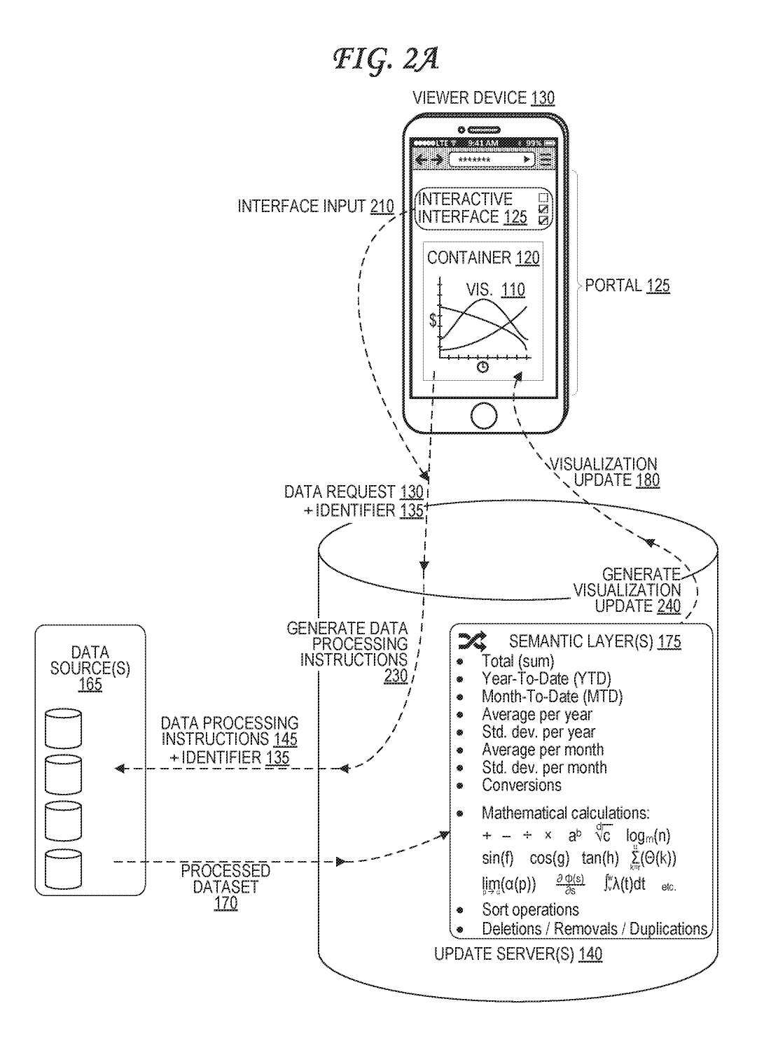

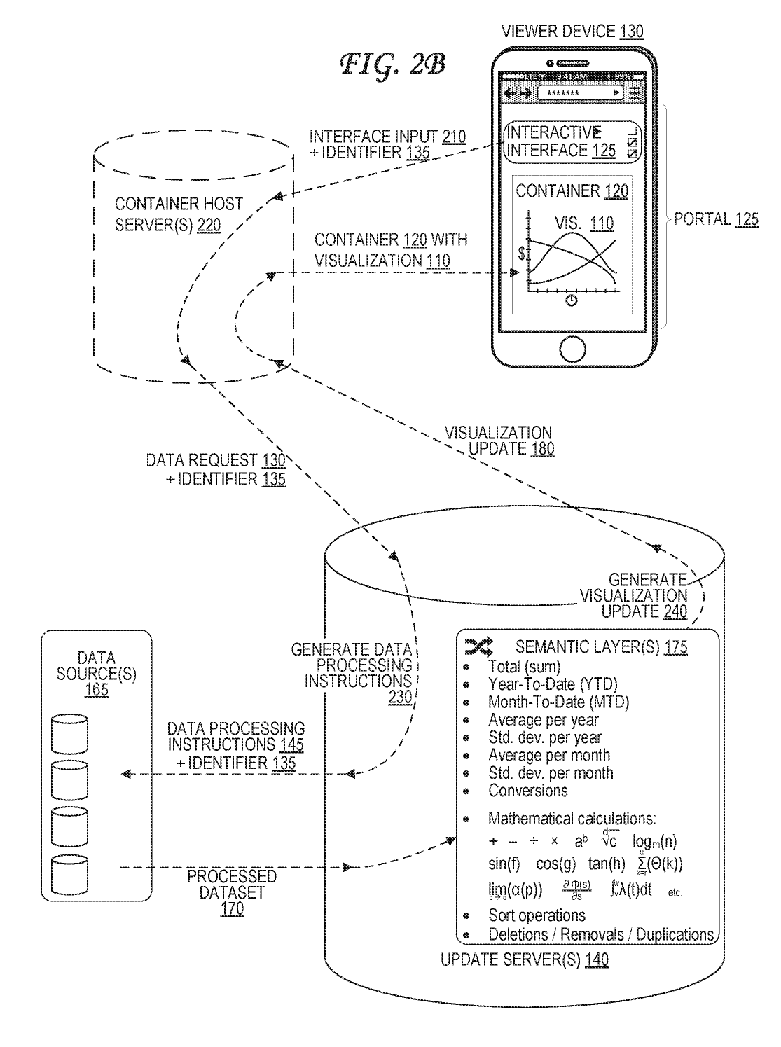

The update server 140 then transmits the visualization update 180 to the viewer device 130 or to a container host server 220 that hosts the container 120 (e.g., see FIG. 2B). The container 120 within the portal 125 thus is updated to include the updated analytic visualization 110. The viewer device 130 thus displays the updated analytic visualization 110 to its user.

In an alternate embodiment (not shown), the update plugin(s) 155 of one or more data server(s) 150 may store and perform certain semantic layer operations 175 instead of, or in concert with, the update server 140. This may increase security in some cases, for example by only supplying yearly total sales data to the update server 140 after a “yearly total” semantic layer operation 175 has been performed at a data server 150, preventing more granular day-to-day sales data from being transmitted to the update server 140.

FIG. 2A illustrates data transfers and data manipulations for updating an analytic visualization not factoring in a container host server.

The data request 130 and identifier 135 of FIG. 2A are both transmitted to the update server 140 from the viewer device 130. The data request 130 may, in some cases, be at least partially based on an interface input 210 from the interactive interface 125. Once the update server 140 receives the data request 130 and identifier 135, it generates the data processing instructions 145 at a step 230.

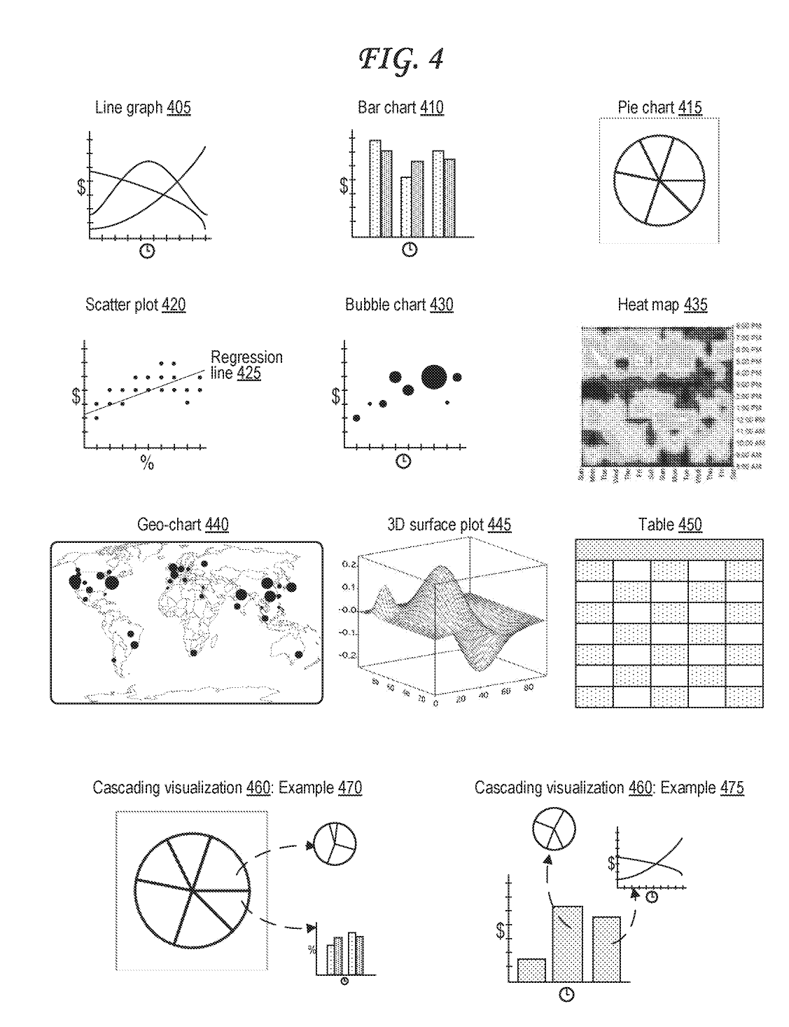

Once the update server 140 receives the processed dataset 170 from the data source(s) 165, the update server 140 checks the data request 130 and/or identifier 135 to see if it should perform any semantic layer operation(s) 175 on the processed dataset 170 before generating the visualization update 180 in step 240. If so, the update server 140 checks the data request 130 and/or identifier 135 to see which semantic layer operation(s) 175 should be performed and performs those semantic layer operations 175 over at least a subset of the processed dataset 170. Each semantic layer operation 175 may include one or more mathematical calculations to be performed, or in some cases may include no mathematical calculations, for example by simply duplicating some subset of data to generate a cascading visualization 460 as illustrated in FIG. 4. The semantic layer operations 175 that are performed at this stage by the update server 140 may be dictated by some combination of the data request 130 and the identifier 135, for example being based partially on interface inputs 210 by the user of the viewer device 130 via the interactive interface 125, based partially on a type of analytic visualization 110 chosen to be displayed (e.g., as illustrated in FIG. 4), and based partially on permissions/authorizations associated with the identifier 135. Alternately, the semantic layer operations 175 performed may be dictated solely by the data request 130 or the identifier 135.

The semantic layer operations 175 can include various calculation operations, such as calculations of totals, year-to-date (YTD) values, month-to-date (MTD) values, averages per year, standard deviations per year, averages per month, standard deviations per month, unit conversions, and other mathematical calculations. For example, semantic layer operations 175 may include sums, differences, products, ratios, percentages, unit conversions, scale changes, and more complex mathematical operations. Such a mathematical operations may include addition operations, subtraction operations, multiplication operations, division operations, exponent operations, root operations, mean operations, median operations, mode operations, standard deviation operations, logarithmic operations, trigonometric operations, statistical operations, derivative operations, integral operations, limit operations, matrix operations, vector operations, Fourier transform operations, unit conversion operations, or some combination thereof. Semantic layer operations 175 may also include sorting operations. In some cases, semantic layer operations 175 may also include non-mathematical operations, such as duplication or removal of one or more data entries from within the processed dataset 170.

Once the semantic layer operations 175 modify the processed dataset 170, the update server 140 generates the visualization update 180 at a step 240. The update server 140 of FIG. 2B then transmits the visualization update 180 directly to the viewer device 130, thereby updating the analytic visualization 110 as displayed by the viewer device 130.

FIG. 2B illustrates data transfers and data manipulations for updating an analytic visualization including data transfers and data manipulations involving a container server.

A container host server 220 is illustrated as the recipient of the visualization update 180 in FIG. 2B. The container host server 220 may be a server that hosts the container 120, which may then be embedded into the portal 125 via an iFrame or one of the other methods described in reference to FIG. 1. In some cases the container host server 220 may also be a portal host server that hosts at least a portion of the portal 125, while in other cases, one or more distinct portal host server(s) (not shown) may host the portal 125.

When the container host server 220 of FIG. 2B receives the visualization update 180, it may generate the updated analytic visualization 110 according to the data in the visualization update 180. The container host server 220 may then serve the container 120 with the updated analytic visualization 110 to the viewer device 110. In some cases, the container host server 220 may serve only the updated analytic visualization 110 or some subset thereof to the viewer device 110, such as when network optimization techniques are used to limit transmitted data to only data that has changed.

The container host server 220 of FIG. 2B is also illustrated as transmitting the data request 130 and optionally the identifier 135 to the update server 140. The container host server 220 of FIG. 2B may optionally receive the identifier 135 from the viewer device 130 and pass it on to the update server 140. The container host server 220 of FIG. 2B may either receive the data request 130 from the viewer device 130, generate the data request 130 itself, or some combination thereof. The data request 130 may be generated by the container host server 220 in real-time, according to a predefined time interval, according to a calendar schedule, based on interface input 210 from the viewer device 130, or some combination thereof.

While FIG. 2A illustrates the viewer device 130 transmitting the data request 130 and the identifier 135 to the update server 140 and FIG. 2B illustrates the container host server 220 transmitting the data request 130 and the identifier 135 to the update server 140, certain embodiments may fall in between. Similarly, while FIG. 2A illustrates the viewer device 130 receiving the visualization update 180 from the update server 140 and FIG. 2B illustrates the container host server 220 receiving the visualization update 180 from the update server 140, certain embodiments may fall in between. For example, in one embodiment, the viewer device 130 transmits the identifier 135 and a first portion of the data request 130 to the update server 140, while the container host server 220 transmits a second portion of the data request 130 to the update server 140 and ultimately receives the visualization update 180 from the update server 140.

While the descriptions of the container host server 220 of FIG. 2B describe the container host server 220 in the singular form, it should be understood that multiple container host servers 220 may be used to host the container 120. For example, one container host server 220 might host markup code while another might host image files, Adobe Flash files, Java applet files, Microsoft Silverlight files, or other files that might be used by the container to display the analytic visualization 110.

While the descriptions of the update server 140 of FIG. 1, FIG. 2A, and FIG. 2B describe the update server 140 in the singular form, it should be understood that multiple update servers 140 may be used to perform at least a subset of the tasks ascribed to the update server 140 above. In such cases the multiple update servers 140 may take turns performing certain tasks, or may perform certain tasks in concert, or may perform certain tasks in a piecemeal fashion, or some combination thereof.

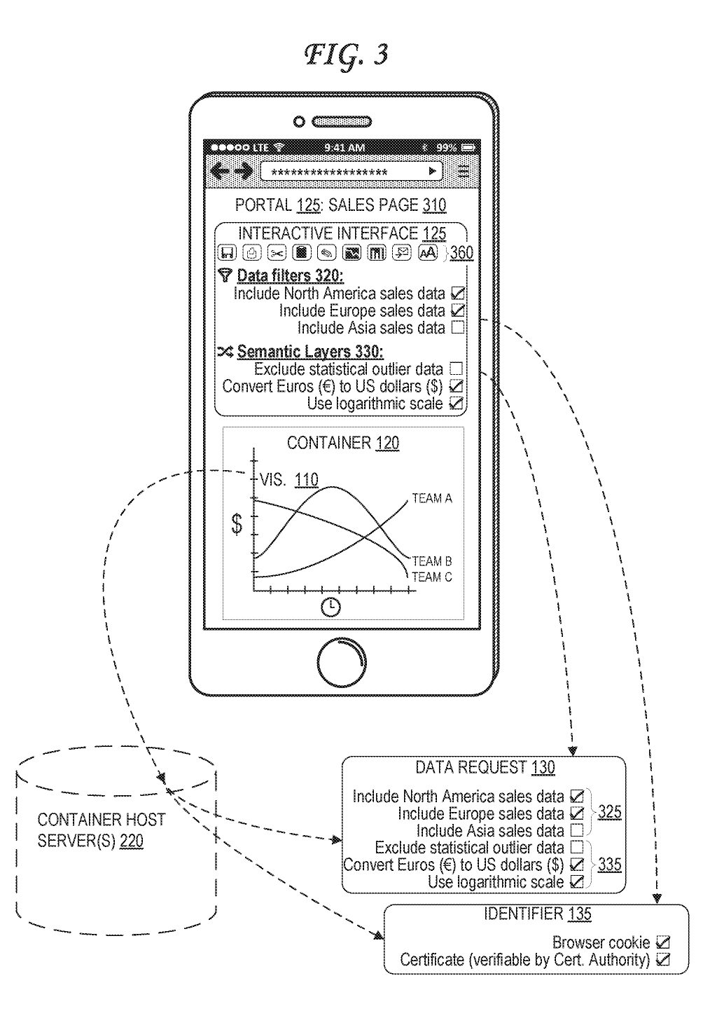

FIG. 3 illustrates an exemplary portal user interface illustrating semantic layer operation selections.

The portal 125 of FIG. 3 is a sales page 310 that shows an analytic visualization 110 charting sales performance of three sales teams: Team A, Team B, and Team C. Besides the analytic visualization 110 in the container 120, the sales page 310 of FIG. 3 also includes an interactive interface 125 that includes various options under a “data filters” category 320 and a “semantic layers” category 330.

The “data filters” category 320 includes an “include North America sales data” option that is checked, an “include Europe sales data” option that is checked, and an “include Asia sales data” option that is not checked. By checking these options in the “data filters” category 320, the user of the viewer device 130 is identifying that they wish to see North America and Europe sales data in the analytic visualization 110, but that Asia sales data should not be included in analytic visualization 110.

Corresponding information 325 in the exemplary data request 130 of identifies that North America and Europe sales data should be included in the analytic visualization 110 but that Asia sales data should not be included in analytic visualization 110. This will be translated into a data processing instruction 145 that instructs the data source(s) to include the North America and Europe sales data in the processed data set 170 but to omit the Asia sales data from the processed data set 170.

The “semantic layers” category 330 includes an “exclude statistical outlier data” option that is not checked, a “convert euros ( [symbol] ) to US dollars ($)” option that is checked, and a “use logarithmic scale” option that is checked. By checking these options in the “semantic layers” category 330, the user of the viewer device 130 is identifying that they wish to not exclude statistical outlier data, that they wish to convert data that is expressed in Euros ( [symbol] ) into data that is expressed in US dollars ($) via exchange rate conversion, and that they wish the analytic visualization 110 to display data using a logarithmic scale. Statistical outlier data may refer to data whose difference from an average value falls outside of a predetermined multiple of a standard deviation value.

Corresponding information 335 in the exemplary data request 130 identifies that statistical outlier data should not be excluded from the visualization update 180, that any data expressed in Euros ( [symbol] ) within the processed dataset 170 should be converted into US dollars ($) in the visualization update 180 via exchange rate conversion, and that the visualization update 180 should be tweaked to ensure that the analytic visualization 110 is displayed using a logarithmic scale.

The interactive interface 125 of FIG. 3 also includes a row of icon buttons 360. The icon buttons 360 include, from left-to-right order, a “save” button that can save a copy of the analytic visualization 110, a “print” button allowing a user to print a copy of the portal 125 with its analytic visualization 110, a “cut/copy” button allowing the user to cut or copy the analytic visualization 110, a “paste” button allowing the user to paste a copied analytic visualization 110, an “edit” button allowing the user to edit the analytic visualization 110 (e.g., via the generation interface 115 of the publisher 105), a “line graph” button allowing the user to format the analytic visualization 110 as a line graph, a “bar chart” button allowing the user to format the analytic visualization 110 as a bar chart, a “share” button allowing the user to share the analytic visualization 110 and/or the portal 125 with another user via email or text message or social media, and a “text size” button allowing the user to adjust text within the analytic visualization 110.

An identifier 135 dataset is also illustrated in FIG. 3. The identifier 135 of FIG. 3 includes both a browser cookie and a certificate verifiable by a Certificate Authority. The identifier 135 may include only one of these, or may include multiple browser cookies and/or multiple certificates. The identifier 135 may optionally be omitted altogether.

FIG. 4 illustrates various analytic visualization formats. As illustrated in FIG. 4, an analytic visualization 110 may include a line graph 405, a bar chart 410, a pie chart 415, a scatter plot 420, a bubble chart 430, a heat map 435, a map-based geo-chart 440, a three-dimensional surface plot 445, a table 450, or some combination thereof. While only the three-dimensional surface plot 445 of FIG. 4 is illustrated as conveying data using more than two dimensions, it should be understood that any of these other types of analytic visualizations may be generated in three or more dimensions. Furthermore, while the analytic visualization types illustrated in FIG. 4 are illustrate in black and white, it should be understood that some of these may convey an additional dimension of data by coloring certain points, lines, bars, “slices,” “bubbles,” values, or regions using different colors along a spectrum, or using different color intensities/saturations, or some combination thereof. For example, the heat map 435 may map data along a spectrum from red to blue even through it is illustrated in FIG. 4 mapping data along a spectrum from white to black. Additionally the three-dimensional surface plot 445 could in some cases convey a fourth dimension of data by being colored differently in different regions similarly to the heat map 435. In some cases, a single container 120 may include multiple analytic visualizations 110.

Semantic layer operations 175 may add elements representing calculated values not originally present in the processed data set 170. Such added elements may represent, for example, totals, averages, standard deviations, ratios, or other calculations involving data from one or more other elements, or sorted/unsorted duplicates of other elements. Semantic layer operations 175 may also remove/delete elements originally present in the processed data set 170, such as the components of a total when only the total is meant to be displayed. Such added or removed elements may include columns/rows/entries of a table 450, lines of a line graph 405, bars of a bar chart 410, slices of a pie chart 415, points of a scatter plot 420, bubbles of a bubble chart 430, regions of a heat map 435, bubbles/regions/points of a geo-chart, regions/heights of a 3D surface plot 445, or some combination thereof. Semantic layer operations 175 may also modify or alter existing elements within the processed data set 170 via calculations such as unit conversions or scale conversions (e.g., to a logarithmic or exponential scale). For example, semantic layer operations 175 may modify values/slopes of lines of a line graph 405, heights of bars in a bar chart 410, sizes of a “slices” of a pie chart 415, locations of points in a scatter plot 420, locations and sizes of bubbles in a bubble chart 430, intensities of areas of a heat map 435, intensities of regions of a geo-chart 440, or values of entries in a table 445. In some cases, calculations from one or more semantic layer operation(s) 175 might be used to overlay data over an analytic visualization 110. For example, the regression line 425 illustrated overlaid over the scatter plot 420 could have been generated via one or more semantic layer operation(s) 175.

Some analytic visualizations 110 may be “cascading” analytic visualizations 460 in which selecting a portion of a “main” analytic visualization can result in display of a “secondary” analytic visualization describing the selected portion.

In one example 470 of a cascading visualization 460, a pie graph is displayed as the “main” analytic visualization. Selecting a first segment of the “main” pie graph in example 470 displays a “secondary” analytic visualization in the form of a “secondary” bar chart that illustrates further details about that selected first segment of the “main” pie graph of example 470. Selecting a second segment of the “main” pie graph in example 470 displays a “secondary” analytic visualization in the form of a “secondary” pie graph that illustrates further details about that selected second segment of the “main” pie graph of example 470.

In another example 475 of a cascading visualization 460, a bar chart is displayed as the “main” analytic visualization. Selecting a first segment of the “main” bar chart in example 475 displays a “secondary” analytic visualization in the form of a “secondary” pie chart that illustrates further details about that selected first segment of the “main” bar chart of example 475. Selecting a second segment of the “main” bar chart in example 475 displays a “secondary” analytic visualization in the form of a “secondary” line graph that illustrates further details about that selected second segment of the “main bar chart of example 475.

FIG. 5 illustrates an exemplary computing system 500 that may be used to implement an embodiment of the present invention. For example, any of the computer systems or computerized devices described herein may, in at least some cases, be a computing system 500. The computing system 500 of FIG. 5 includes one or more processors 510 and memory 510. Main memory 510 stores, in part, instructions and data for execution by processor 510. Main memory 510 can store the executable code when in operation. The system 500 of FIG. 5 further includes a mass storage device 530, portable storage medium drive(s) 540, output devices 550, user input devices 560, a graphics display 570, and peripheral devices 580.

The components shown in FIG. 5 are depicted as being connected via a single bus 590. However, the components may be connected through one or more data transport means. For example, processor unit 510 and main memory 510 may be connected via a local microprocessor bus, and the mass storage device 530, peripheral device(s) 580, portable storage device 540, and display system 570 may be connected via one or more input/output (I/O) buses.

Mass storage device 530, which may be implemented with a magnetic disk drive or an optical disk drive, is a non-volatile storage device for storing data and instructions for use by processor unit 510. Mass storage device 530 can store the system software for implementing embodiments of the present invention for purposes of loading that software into main memory 510.

Portable storage device 540 operates in conjunction with a portable non-volatile storage medium, such as a floppy disk, compact disk or Digital video disc, to input and output data and code to and from the computer system 500 of FIG. 5. The system software for implementing embodiments of the present invention may be stored on such a portable medium and input to the computer system 500 via the portable storage device 540.

Input devices 560 provide a portion of a user interface. Input devices 560 may include an alpha-numeric keypad, such as a keyboard, for inputting alpha-numeric and other information, or a pointing device, such as a mouse, a trackball, stylus, or cursor direction keys. Additionally, the system 500 as shown in FIG. 5 includes output devices 550. Examples of suitable output devices include speakers, printers, network interfaces, and monitors.

Display system 570 may include a liquid crystal display (LCD), a plasma display, an organic light-emitting diode (OLED) display, an electronic ink display, a projector-based display, a holographic display, or another suitable display device. Display system 570 receives textual and graphical information, and processes the information for output to the display device. The display system 570 may include multiple-touch touchscreen input capabilities, such as capacitive touch detection, resistive touch detection, surface acoustic wave touch detection, or infrared touch detection. Such touchscreen input capabilities may or may not allow for variable pressure or force detection.

Peripherals 580 may include any type of computer support device to add additional functionality to the computer system. For example, peripheral device(s) 580 may include a modem or a router.

The components contained in the computer system 500 of FIG. 5 are those typically found in computer systems that may be suitable for use with embodiments of the present invention and are intended to represent a broad category of such computer components that are well known in the art. Thus, the computer system 500 of FIG. 5 can be a personal computer, a hand held computing device, a telephone (“smart” or otherwise), a mobile computing device, a workstation, a server (on a server rack or otherwise), a minicomputer, a mainframe computer, a tablet computing device, a wearable device (such as a watch, a ring, a pair of glasses, or another type of jewelry/clothing/accessory), a video game console (portable or otherwise), an e-book reader, a media player device (portable or otherwise), a vehicle-based computer, some combination thereof, or any other computing device. The computer system 500 may in some cases be a virtual computer system executed by another computer system. The computer can also include different bus configurations, networked platforms, multi-processor platforms, etc. Various operating systems can be used including Unix, Linux, Windows, Macintosh OS, Palm OS, Android, iOS, and other suitable operating systems.

In some cases, the computer system 500 may be part of a multi-computer system that uses multiple computer systems 500, each for one or more specific tasks or purposes. For example, the multi-computer system may include multiple computer systems 500 communicatively coupled together via at least one of a personal area network (PAN), a local area network (LAN), a wireless local area network (WLAN), a municipal area network (MAN), a wide area network (WAN), or some combination thereof. The multi-computer system may further include multiple computer systems 500 from different networks communicatively coupled together via the internet (also known as a “distributed” system).

While various diagrams provided and described above may show a particular order of operations performed by certain embodiments of the invention, it should be understood that such order is exemplary. Alternative embodiments may perform the operations in a different order, combine certain operations, overlap certain operations, or some combination thereof.

The foregoing detailed description of the technology has been presented for purposes of illustration and description. It is not intended to be exhaustive or to limit the technology to the precise form disclosed. Many modifications and variations are possible in light of the above teaching. The described embodiments were chosen in order to best explain the principles of the technology, its practical application, and to enable others skilled in the art to utilize the technology in various embodiments and with various modifications as are suited to the particular use contemplated. It is intended that the scope of the technology be defined by the claim.

What is claimed is:

1. A system for providing analytic visualization data, the system comprising:
a memory storing a semantic layer operation;
a communication transceiver communicatively coupled to at least a data source, the communication transceiver receiving a data request; and
a processor coupled to the memory and to the communication transceiver, wherein execution of instructions stored in the memory by the processor:
generates data processing instructions based on the data request,
triggers transmission of the data processing instructions to the data source via the communication transceiver,
receives a processed dataset from the data source, the processed dataset being at least a subset of a full dataset stored at the data source,
modifies the processed dataset by performing the semantic layer operation on the processed dataset,
generates a visualization update based on the modified processed dataset,
triggers transmission of the visualization update via the communication transceiver, thereby updating an analytic visualization that is displayed by a viewer device.

2. The system of claim 1, wherein the memory also stores additional semantic layer operations distinct from the semantic layer operation, and wherein the data request identifies the semantic layer operation.

3. The system of claim 1, wherein the data request is based on an interface input received at the viewer device.

4. The system of claim 1, wherein the communication transceiver transmits at least a portion of the visualization update to one of the viewer device or a container host server that hosts a container through which the analytic visualization served to the viewer device.

5. The system of claim 1, wherein the communication transceiver receives at least a portion of the data request from one of the viewer device or a container host server that hosts a container through which the analytic visualization served to the viewer device.

6. The system of claim 1, wherein the communication transceiver receives an identifier, the identifier including at least one of a browser cookie or a certificate.

7. The system of claim 6, wherein execution of the instructions by the processor also transmits the identifier to the data source.

8. The system of claim 6, wherein execution of the instructions by the processor generates the data processing instructions based on the identifier as well as on the data request.

9. The system of claim 1, wherein the visualization update includes the analytic visualization.

10. The system of claim 1, wherein the visualization update is interpretable by one or more output devices to generate the analytic visualization based on the visualization update, the one or more output devices including at least one of the viewer device or a container host server that hosts a container in which the analytic visualization is embedded.

11. The system of claim 1, wherein the semantic layer operation includes at least one of an addition operation, a subtraction operation, a multiplication operation, a division operation, an exponent operation, a root operation, a mean operation, a median operation, a mode operation, a standard deviation operation, a logarithmic operation, a trigonometric operation, a statistical operation, a derivative operation, an integral operation, a limit operation, a matrix operation, a vector operation, a Fourier transform operation, a unit conversion operation, a sorting operation, a duplication operation, a deletion operation, or some combination thereof.

12. The system of claim 1, wherein the communication transceiver further receives a semantic layer input defining the semantic layer operation.

13. The system of claim 1, wherein the data source includes a data server that stores a data plugin, the data plugin executable by a data server processor of the data server to generate the processed data set based on the data processing instruction and the full dataset.

14. The system of claim 13, wherein the data source includes one or more additional data servers distinct from the data server, wherein each additional data server includes at least a subset of the full dataset.

15. A method of providing analytic visualization data, the method comprising:
storing a semantic layer operation in a memory;
receiving a data request;
generating data processing instructions based on the data request;
transmitting the data processing instructions to a data source;
receiving a processed dataset from the data source, the processed dataset being at least a subset of a full dataset stored at the data source;
modifying the processed dataset by performing the semantic layer operation on the processed dataset;
generating a visualization update based on the modified processed dataset;
transmitting the visualization update, thereby updating an analytic visualization that is displayed by a viewer device.

16. The method of claim 15, further comprising storing additional semantic layer operations in the memory, the additional semantic layer operations distinct from the semantic layer operation, and wherein the data request identifies the semantic layer operation.

17. The method of claim 15, further comprising:
receiving an identifier; and
transmitting the identifier to the data source.

18. The method of claim 15, further comprising receiving an identifier, and wherein generating the data processing instructions is based on the identifier as well as on the data request.

19. The method of claim 15, wherein the visualization update is transmitted to at least one of viewer device, a container host server that hosts a container in which the analytic visualization is embedded, or some combination thereof.

20. A non-transitory computer-readable storage medium, having embodied thereon a program executable by a processor to perform a method for providing analytic visualization data, the method comprising:
storing a semantic layer operation;
receiving a data request;
generating data processing instructions based on the data request;
transmitting the data processing instructions to a data source;
receiving a processed dataset from the data source, the processed dataset being at least a subset of a full dataset stored at the data source;
modifying the processed dataset by performing the semantic layer operation on the processed dataset;
generating a visualization update based on the modified processed dataset;
transmitting the visualization update, thereby updating an analytic visualization that is displayed by a viewer device.
